(19) United States
(12) Patent Application Publication
(10) Pub. No.: US 2026/0266652 A1
(43) Pub. Date: Sep. 10, 2026

(54) DISTRIBUTED SOUND EXPOSURE ESTIMATION USING HOST AND REMOTE DEVICE DATA

(71) Applicants: Yaaqov Guetta, Netanya (IL); Pawel Trella, Gdansk (PL); Balvinder Pal Singh, Chhattisgarh (IN); Adam Kupryjanow, Gdansk (PL); Ehud Apsel, Sitria (IL)

(72) Inventors: Yaaqov Guetta, Netanya (IL); Pawel Trella, Gdansk (PL); Balvinder Pal Singh, Chhattisgarh (IN); Adam Kupryjanow, Gdansk (PL); Ehud Apsel, Sitria (IL)

(21) Appl. No.: 19/664,524

(22) Filed: Apr. 30, 2026

(51) Int. Cl. G01H 3/14; H04R 1/10; H04R 3/00; H04R 29/00

(52) U.S. Cl. CPC G01H 3/14; H04R 1/1083; H04R 3/002; H04R 29/004; H04R 2420/07; H04R 2430/01

(57) ABSTRACT

Systems and methods are provided for distributed sound exposure estimation using a host device and a remote audio device. The host device transmits snapshot commands that define measurement window boundaries and receives, for each measurement window, a payload from the remote audio device along with capability data. The host uses a host clock to determine window duration and estimates a playback contribution based on host-side digital audio level and gain. Depending on the capability data, the payload represents either a direct in-ear SPL measurement (when an in-ear microphone is present) or a residual SPL value derived from environmental sound and effective attenuation. The host determines a combined in-ear SPL for the measurement window by using the payload directly for direct-measurement operation or by combining the playback contribution and the residual SPL. The host integrates the combined in-ear SPL over time across successive measurement windows to determine a sound exposure dose.

### TECHNICAL FIELD

This disclosure relates generally to sound exposure, and in particular, to distributed sound exposure estimation.

### BACKGROUND

Excessive sound exposure over time can contribute to hearing fatigue and long-term hearing health risk. Accurately estimating a listener's sound exposure is important for enabling timely user feedback and protective actions. Accurately estimating a listener's total sound exposure (dose) includes accounting for both the audio played by the device (playback) and the external environmental noise reaching the ear (residual ambient).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 presents a block diagram illustrating a system for distributed sound exposure estimation, in accordance with various embodiments.

FIG. 2 is a sequence diagram illustrating an example of a sound energy level accumulation protocol, according to various embodiments.

FIG. 3 is a flowchart illustrating an example method for distributed sound exposure estimation, in accordance with various embodiments.

FIG. 4 is a flowchart illustrating an example method for managing runtime changes that can affect a listener's estimated sound exposure in a distributed architecture, in accordance with various embodiments.

FIG. 5 illustrates an example flowchart of a method in which a host device cooperates with a remote audio device to estimate a combined in-ear sound exposure level, in accordance with various embodiments.

FIGS. 6A-6B illustrate example compact command/response packets for exchanging window-aligned sound exposure levels between a host device and a remote audio device, in accordance with various embodiments.

FIG. 7 is a block diagram of an example deep learning system, in accordance with various embodiments.

FIG. 8 is a block diagram of an example computing device, in accordance with various embodiments.

### DESCRIPTION

### Overview

Systems and methods are provided for distributed sound exposure estimation. In particular, systems and methods are provided for accurate sound exposure monitoring on standard consumer platforms by combining host-side playback knowledge with remote-side environmental measurements. The techniques provide accurate sound exposure monitoring without using an in-ear microphone or the remote device to compute full sound exposure level (SEL). Excessive sound exposure accumulated over time can contribute to hearing fatigue and long-term hearing health risk, and therefore accurate estimation of a listener's sound exposure (e.g., SEL and/or dose) is important for enabling timely user feedback and protective actions. In many practical listening scenarios, total exposure at the ear is influenced not only by the playback signal delivered to the headphones, but also by environmental noise that reaches the ear as residual ambient sound after any passive and/or active attenuation. Accordingly, the techniques provided herein address the technical challenge of estimating total in-ear exposure in a manner that accounts for both playback and residual ambient contributions while remaining suitable for cost-effective consumer platforms.

Conventional approaches often force a tradeoff between headset-centric and host-centric architectures, which each have significant limitations. A headset-centric architecture may attempt to compute dose on the headset itself, which can require specialized sensing hardware (such as an in-ear microphone) and/or an always-on digital signal processor (DSP), thereby increasing bill of materials, battery drain, firmware complexity, and timing/clock management burdens. A host-centric architecture may estimate exposure solely from playback volume information available at the host (e.g., PC or phone), but such approaches can ignore the environmental component and the variable attenuation provided by active noise cancellation (ANC), leading to potentially significant underestimation of exposure risk in noisy environments. The systems and methods provided herein provide a practical middle ground that improves accuracy without specialized in-ear sensing or a remote device to perform full SEL computation.

In some implementations, a distributed system is provided that includes a host device (e.g., laptop, smartphone, or other computing platform) and a remote audio device (e.g., headset, earbuds, or other audio peripheral) coupled via a wireless link (for example, a Bluetooth Low Energy (BLE) connection). The host device may act as a central calculation engine and system clock, while the remote audio device may operate as a lightweight sensor node that measures or derives environment-related metrics. The distributed system can reduce computational and power burdens on the remote audio device while enabling the host device to deliver exposure tracking and user feedback across a broad ecosystem of peripherals.

In some examples, the host device includes an audio driver that monitors playback information available on the host side, such as digital audio level expressed relative to full scale (dBFS) and gain (e.g., volume settings). The host device may further include a dose engine configured to perform exposure integration and to apply regulatory or policy logic (e.g., compliance-oriented dose metrics and alerts). In some implementations, the host device may request measurement data from the remote audio device over time and may integrate total exposure using host-side timing to generate user-facing safety warnings, dashboards, and/or other notifications.

In some implementations, the remote audio device includes one or more sensors and/or signal processing components that capture environmental noise and characterize attenuation. For example, the remote audio device may include an ambient microphone and ANC DSP components that enable estimation of an ambient sound pressure level (SPL) and an effective attenuation metric, such as total insertion loss associated with ANC operation and/or passive isolation. The remote audio device may further include a window accumulator that aggregates energy or summary metrics over a measurement interval, thereby avoiding continuous high-bandwidth streaming of raw microphone data and reducing power consumption and reducing the amount of time the device's wireless radio and/or transceiver is actively powered on. The remote audio device may also store a static sensitivity calibration value (e.g., a mapping between 0 dBFS playback level and a corresponding SPL) that enables the host device to convert digital playback levels into physical SPL estimates.

According to various implementations, a host-framed accumulation protocol can be used, in which the host defines measurement windows and the remote device returns window-aligned aggregates. In various examples, a host-framed accumulation protocol can support accurate time alignment without shared clock synchronization. Using the host-framed accumulation protocol, the host may issue commands that delineate window boundaries (e.g., snapshot type commands), and the remote device may respond with aggregated measurement payloads for the interval since the prior command boundary and then reset internal accumulators for the next interval. Because the host controls the window boundaries and measures the interval duration using its own system clock, the host can perform SEL/dose integration without relying on remote timestamps or explicit clock synchronization.

In some examples, the wireless protocol is implemented as a compact command/response interface that reduces airtime and supports deterministic association between host commands and remote responses. A command packet may include an operation identifier (e.g., a continue-type snapshot to capture and reset while continuing accumulation, and/or a stop-type snapshot to capture, reset, and discontinue accumulation for power savings) and a sequence identifier generated by the host. A response packet may echo the sequence identifier and may include configuration data (including sensitivity), capability flags (e.g., whether ANC is active, whether an ambient microphone measurement is valid, and/or whether in-ear measurement is valid), and a measurement payload that represents either direct in-ear SPL or an ambient-based residual SPL estimate derived from ambient noise and insertion loss.

In some implementations, the host device supports multiple calculation modes to scale across different hardware tiers using a single host driver. The calculation modes can include a hybrid calculation mode and a direct measurement mode. In the hybrid estimation mode, the host may determine a playback-side SPL estimate by combining the monitored digital level (dBFS), gain, and the reported sensitivity calibration. The host may further determine a residual ambient SPL estimate by combining a reported ambient SPL with an attenuation metric such as total insertion loss. The host may then combine playback and residual contributions in an energy domain based on an assumption that playback and residual ambient are substantially uncorrelated, thereby generating a combined in-ear SPL for each measurement window that can be integrated over time for exposure estimation. In various examples, the hybrid estimation mode can be used in devices that lack an in-ear microphone.

The direct measurement mode can be used in devices equipped with an in-ear microphone. In the direct measurement mode, the remote audio device can provide a payload representing measured in-ear SPL, and the host can use the reported in-ear SPL directly for dose integration. Thus, according to various examples, the architecture can leverage higher-fidelity sensing when available (e.g., in devices having an in-ear microphone) while still providing a robust exposure-tracking framework for devices that only support ambient sensing. This dual-mode capability allows for consistent host-side exposure reporting behavior across a heterogeneous set of peripherals without each peripheral device implementing full dose computation logic.

According to some implementations, dynamic changes during a measurement window can be handled by the system in a variety of ways. For example, when playback gain changes occur within a window, the host may trigger additional snapshots around a change event or, in a lower-overhead approach, may apply a worst-case gain observed during the window to avoid underestimating exposure. Similarly, when ambient SPL and/or insertion loss varies during a window (e.g., due to ANC mode changes), the remote device may perform more precise integration over the window or may report worst-case metrics such as maximum ambient SPL and minimum insertion loss observed during the window. In various examples, the techniques can be selected to balance accuracy and power consumption in real-world usage, and to reduce on-device compute and radio activity while maintaining safety-conservative exposure estimates.

In various implementations, the distributed sound exposure estimation architecture provided herein enables accurate monitoring and reporting of listener exposure on standard consumer platforms by combining host-side playback knowledge with remote-side environmental and attenuation measurements. Additionally, the distributed sound exposure estimation architecture avoids the use of specialized in-ear microphones and remote-side full SEL/dose computation. By using host-defined measurement windows, window-aligned remote aggregates, compact command/response messaging, and multi-tier calculation modes, the system can provide scalable hearing health functionality (including dose tracking and safety warnings) that adapts to varying peripheral capabilities and listening environments, including scenarios with elevated ambient noise and varying ANC behavior.

For purposes of explanation, specific numbers, materials, and configurations are set forth in order to provide a thorough understanding of the illustrative implementations. However, it will be apparent to one skilled in the art that the present disclosure may be practiced without the specific details or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as implying that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but

these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example System for Distributed Sound Exposure Estimation

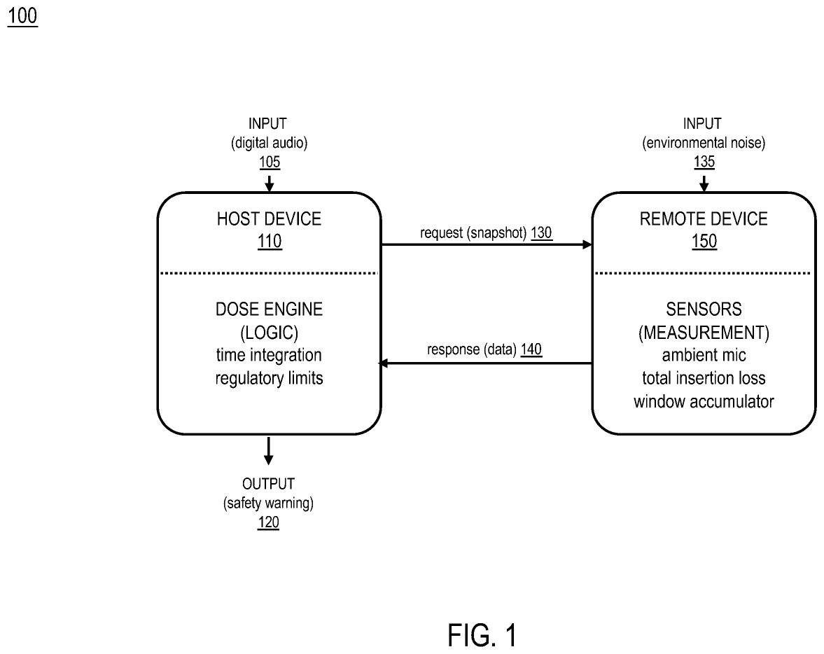

FIG. 1 presents a block diagram illustrating a system 100 for distributed sound exposure estimation, in accordance with various embodiments. As shown in FIG. 1, the system 100 includes a host device 110 and a remote device 150. The host device 110 cooperates with the remote device 150 to estimate a listener's sound exposure based on both playback audio and environmental conditions. In some implementations, the host device 110 includes a dose engine. The dose engine includes processing logic that can request data from the remote device 150 and integrate the total sound exposure over time. The dose engine can apply one or more regulatory limits to determine exposure metrics and generate corresponding user feedback. The host device 110 may generate an output 120 (e.g., a safety warning) when one or more exposure criteria are satisfied.

In some examples, the host device 110 receives an input 105 representing audio content to be rendered via the remote device 150. The host device 110 may monitor one or more host-side playback parameters associated with the digital audio, including a digital playback volume (e.g., decibels relative to full scale (dBFS)) and a gain setting. The host device 110 can use the host-side playback parameters to characterize playback contribution to sound exposure. In some implementations, host-side monitoring is performed by an audio driver or other audio pipeline component executing on the host device 110, and the monitored playback parameters are made available to the dose engine for subsequent exposure determination.

According to various implementations, the remote device 150 can be exposed to an input 135 (e.g., environmental noise), which represents ambient acoustic energy present in the listener's environment. In some examples, the remote device 150 includes sensors configured to capture environmental information relevant to sound exposure at the ear. The sensors can include various measurement sensors. In some examples, the sensors include an ambient microphone for sensing ambient sound pressure level. In some examples, the sensors include circuitry for determining an effective attenuation metric. The circuitry for determining an effective attenuation metric may include an acoustic noise cancellation (ANC) signal-processing path (e.g., a ANC digital signal processor). In some examples, the remote device 150 includes a window accumulator that can include a temporary buffer that accumulates noise energy between host requests, such that raw data is not continuously streamed. In some examples, the remote device 150 includes a fixed calibration value stored on the device (e.g., “105 dB SPL at 0 dBFS”) which allows the host to map the digital audio level (dBFS) to the corresponding physical sound pressure level (dBSPL). According to various examples, the remote device 150 can provide environment-related measurements that complement host-side playback knowledge.

According to various examples, total insertion loss is not measured at runtime. Instead, total insertion loss is a metric measured in an audio laboratory during a product R&D phase (e.g., for each ANC setting) using a measurement setup that includes, for example, Artificial Ears and a background-noise simulation system. The measured total insertion loss values can be stored in a memory of the remote device 150. In various implementations, the measured total insertion loss values can be used to properly scale level results. For example, in one approach the remote device 150 measures ambient SPL using a microphone outside of an ear canal and the system corrects the ambient SPL using the stored total insertion loss to estimate a residual ambient SPL at the ear. In another approach, the remote device 150 measures SPL using a microphone inside the ear canal (e.g., an in-ear microphone), and the system can bypass total insertion loss because the in-ear measurement reflects the attenuated sound field at or near the eardrum.

In some implementations, the system 100 is arranged so that the host device 110 performs a majority of the computations, while the remote device 150 operates as a relatively lightweight sensor node to conserve remote-device resources (e.g., power and complexity). For example, rather than the remote device 150 determining full dose integration, the remote device 150 can provide aggregated measurement metrics to the host device 110, and the host device 110 can determine exposure over time based on its own timing reference. Performing exposure determinations on the host device allows for operation of the system with cost-effective remote devices. According to various examples, the techniques provided herein increase accuracy of exposure estimation relative to host-only approaches that ignore environmental contributions and attenuation variability.

As shown in FIG. 1, the host device 110 transmits a request 130 (e.g., a snapshot) to the remote device 150 and receives a response 140 (e.g., data) from the remote device 150. In some examples, the request 130 defines a measurement boundary for a host-framed measurement window, and the response 140 includes one or more window-aligned metrics aggregated over an interval since a prior request. By framing measurement windows at the host device 110 and receiving window-aligned aggregates from the remote device 150, the system 100 can avoid reliance on shared clocks or explicit timestamp synchronization between devices while still enabling time integration at the host device 110. In various examples, time integration refers to accumulating (or integrating) a quantity over a duration of time, rather than referring to an instantaneous value.

In some implementations, the remote device 150 includes a window accumulator configured to accumulate noise-related energy or statistics between host-issued requests. In some examples, the window accumulator reduces or eliminates the need to continuously stream raw microphone data. For example, the remote device 150 may accumulate an aggregate value representative of ambient conditions (and/or residual ambient conditions after attenuation) during the measurement window. The remote device 150 may reset the accumulation in response to the request 130. The use of the window accumulator can reduce wireless bandwidth usage and can support lower-power operation of the remote device 150.

In some examples, the response 140 from the remote device 150 includes information usable by the host device 110 to estimate a residual ambient contribution at the ear. In some examples, the information in the response 140 can include an ambient SPL metric and an attenuation metric (e.g., total insertion loss). In some examples, the information in the response 140 can include a derived residual SPL metric based on ambient SPL and total insertion loss. In some implementations, the host device 110 also obtains or receives a sensitivity calibration value for the remote device 150 that maps a digital playback level to a physical SPL estimate, enabling the host device 110 to convert the input (digital audio) 105 and associated gain information into a playback SPL estimate.

In some implementations, the dose engine of the host device 110 combines the playback SPL contribution estimated from host-side playback parameters and sensitivity calibration, and the residual ambient SPL contribution estimated from the response 140 to determine a combined in-ear SPL estimate for the measurement window. In some examples, the host device 110 determines the combination in an energy domain (rather than by direct summation in decibels) to reflect that playback and residual ambient contributions can be treated as substantially uncorrelated. The host device 110 can perform time integration using a host-side clock to determine cumulative exposure (e.g., SEL/dose) and evaluate the cumulative exposure against one or more regulatory limits.

In some examples, sound exposure level (SEL) may be defined in terms of integrated squared sound pressure as E=∫p²(t) dt and expressed in decibels as:

$$S E {L}_{d B} = 10 {log}_{10} ( E / ( {p}_{0}^{2} \cdot {t}_{0} ) )$$

where p₀ is a reference sound pressure (20 μPa in air) and to is a reference duration (1 s). In various examples, these definitions support policy-neutral integration and subsequent conversion into user-facing dose metrics or alerts under a selected exposure policy.

In some examples, the request/response exchange of FIG. 1 is implemented over a short-range wireless link, such as Bluetooth Low Energy, using a compact command/response format to reduce wireless transaction overhead. For instance, the host device 110 can periodically poll the remote device 150 (e.g., at intervals selected to balance responsiveness and power consumption), and the remote device 150 can return aggregated measurement payloads in response, thereby reducing wireless radio active time and associated power consumption relative to continuous streaming. Based on the computed exposure and any applicable policy thresholds, the host device 110 may generate the output 120 (e.g., a safety warning) to provide timely user feedback and protective actions.

### Example Sequence Diagram for Distributed Sound Exposure Estimation

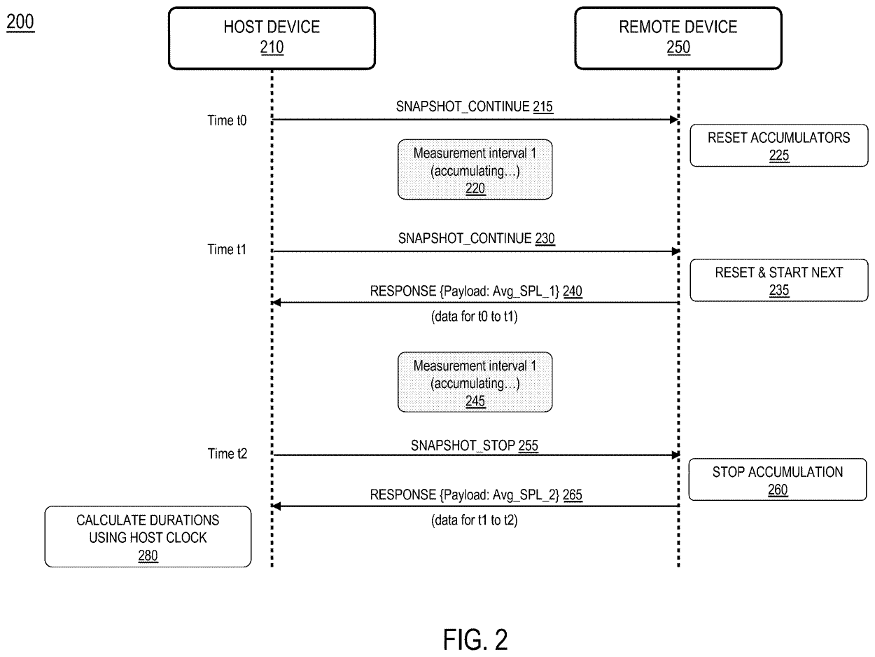

FIG. 2 is a sequence diagram 200 illustrating an example of a sound energy level accumulation protocol, according to various embodiments. In particular, FIG. 2 illustrates an example host-framed accumulation protocol in which a host device 210 defines measurement boundaries and a remote device 250 returns window-aligned aggregate metrics for use in host-side exposure estimation. In some implementations, the accumulation protocol is executed over a wireless link (e.g., Bluetooth Low Energy), and is configured so that the host device acts as a controlling device that initiates data collection windows and requests snapshot data from the remote device.

In some examples, at time to, the host device 210 transmits a snapshot command snapshot_continue 215 to the remote device 250. In response to receiving the snapshot command, the remote device 250 resets one or more internal accumulators, as indicated by reset accumulators 225. The remote device 250 then begins accumulating noise-related energy for a first measurement interval. In some implementations, the remote device 250 does not rely on absolute time, and instead accumulates until a next host command is received, thereby avoiding clock synchronization.

During the first measurement interval 220, the remote device 250 performs remote aggregation while environmental conditions and/or attenuation conditions may vary. In some examples, the remote device can calculate an aggregate value (e.g., average residual noise) for the time interval since the previous command boundary. Aggregation at the remote device 250 can be supported by a window accumulator that accumulates noise energy between host requests, which avoids continuously streaming raw data.

At time t1, the host device 210 transmits a subsequent snapshot command snapshot_continue 230, which marks an end of the prior window and a start of a new window. In some implementations, the remote device 250 generates and transmits a response 240 that includes a window-aligned payload, and the response 240 can correspond to data for t0 to t1. In connection with transmitting the response 240, the remote device 250 can reset internal accumulators and begin accumulating for a next interval, as indicated by reset & start next 235.

In some examples, the command/response pattern illustrated in FIG. 2 provides an inherent association between each response 240 payload and the host-defined measurement window, because the remote device 250 resets its accumulator at each command boundary. As a result, the host device 210 can receive window-aligned aggregate metrics without the remote device 250 transmitting explicit timestamps, and without shared clock synchronization between the host device 210 and the remote device 250. In some implementations, the architecture reduces computational and power burdens on the remote device 250, because the remote device 250 can operate as a lightweight sensor node that primarily measures and aggregates environment-related metrics.

FIG. 2 further illustrates that, after one or more accumulation windows, the host device 210 may transmit a termination command snapshot_stop 255 at time t2. In response, the remote device 250 can provide a final window payload, illustrated as response 265, corresponding to data for t1 to t2, and can discontinue further accumulation as indicated by stop accumulation 260. In some examples, the stop behavior can reduce remote device 250 activity and power usage when monitoring is not being performed.

In some implementations, the host device 210 determines window durations using a host clock, as indicated by the calculate durations using host clock block 280. For example, the host device 210 can determine a window duration as delta_t=t1−t0 using the host device 210 system clock, and the host device 210 can then use the computed duration to determine exposure over the corresponding window. The host device 210 can similarly determine window duration for subsequent windows. In this manner, timekeeping and integration can be centralized at the host device 210, while the remote device 250 supplies window-aligned measurement payloads.

In some examples, the response payloads (e.g., avg_spl_1 and avg_spl_2) in the responses 240, 265 represent aggregate SPL-related values derived from environmental measurements and attenuation behavior during the corresponding windows. For instance, the remote device 250 may capture ambient noise via an ambient microphone and determine an effective attenuation metric such as total insertion loss. The remote device 250 may report a derived residual SPL value and/or an aggregate statistic of the derived residual SPL value for the window. The host device 210 can combine the payload values with host-side playback knowledge to estimate a combined in-ear SPL and to perform exposure integration over time.

In some implementations, the sequence diagram 200 shown in FIG. 2 is implemented using a compact command/response format in which the host device 210 sends a command packet and the remote device 250 returns a response packet shortly thereafter, thereby supporting short, periodic exchanges rather than continuous streaming. In some examples, the compact binary protocol structure minimizes radio on-time and power consumption, while still allowing the host device 210 to maintain a continuous exposure history through window-by-window time integration.

### Example Method for Distributed Sound Exposure Estimation

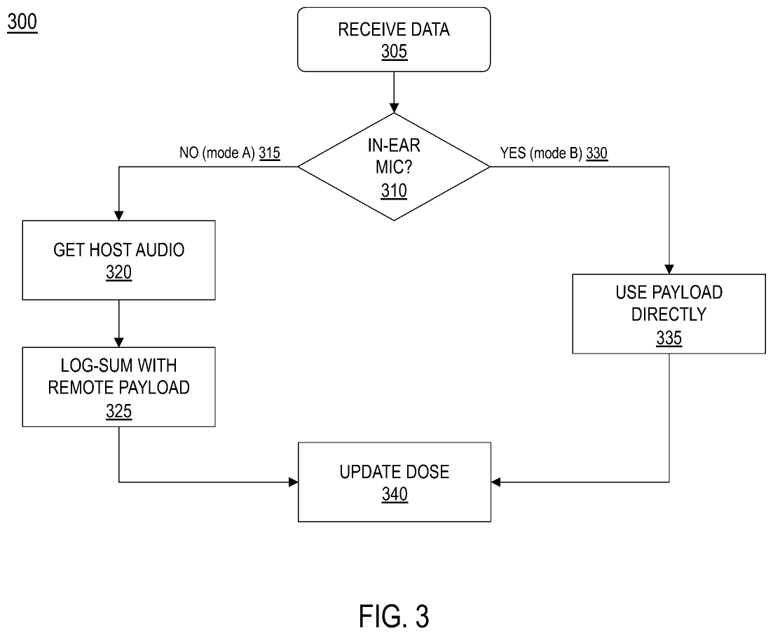

FIG. 3 is a flowchart illustrating an example method 300 for distributed sound exposure estimation, in accordance with various embodiments. In various examples, the method 300 is performed at the host device. In particular, the method 300 illustrates an example flow for host-side sound exposure determination logic that supports multiple calculation modes. The calculation mode is selected based on capabilities of a remote audio device. In some implementations, the processing shown in FIG. 3 is performed by a dose engine or other processing logic executing on a host device (e.g., a personal computer, a smartphone, etc.) that cooperates with a remote audio device (e.g., earphones, headphones, a headset, etc.) to estimate a listener's sound exposure over time.

In some implementations, a host-centric exposure estimator that relies solely on playback volume can systematically underestimate a listener's true in-ear exposure when residual ambient noise is non-negligible. In various examples, exposure increases as the residual ambient noise level approaches the playback level, and therefore the underestimation can become substantial in noisy environments even when the playback volume remains unchanged. As a concrete example, consider a scenario in which a user listens to music at 85 dBA (often treated as safe for 8 hours/day), while in a noisy environment (e.g., an airplane) a residual noise level leaking through active noise cancellation is also 85 dBA. In this scenario, the total acoustic energy at the ear doubles, which corresponds to an effective level increase of 3 dB (i.e., 88 dBA). Under a 3 dB exchange rate used in safety standards (NIOSH/WHO), an increase of 3 dB halves the permissible exposure duration, such that 88 dBA corresponds to 4 hours rather than 8 hours. Accordingly, a host-only approach that accounts for playback (85 dBA) but ignores residual ambient contribution may fail to warn a user when the 4-hour mark is exceeded, despite the user experiencing the higher effective level. The method 300 of FIG. 3 can prevent this overexposure by providing a more accurate estimate of a listener's sound exposure over time.

At 305, data is received from the remote audio device as part of a host-initiated, window-aligned measurement exchange. In some implementations, the received data includes a measurement payload representative of sound pressure level (SPL) at or near the user's ear, along with configuration and/or capability information usable by the host to determine how the payload should be interpreted. For example, the payload may represent a residual SPL estimate derived from environmental sensing (e.g., ambient noise and attenuation), or may represent a directly measured in-ear SPL when a corresponding sensor is available on the remote audio device.

At 310, the host determines whether an in-ear microphone is present in the remote device. In particular, the host may determine whether an in-ear microphone measurement capability is available (e.g., whether an in-ear microphone is present and valid for direct measurement). In some implementations, the in-ear microphone determination is made based on capability signaling from the remote audio device (for example, a flag indicating whether an in-ear microphone measurement is valid). When the in-ear microphone measurement capability is not available, the method proceeds to a hybrid estimation path (mode A) at 315. When the in-ear microphone measurement capability is available, the method proceeds to a direct measurement path (mode B) at 330.

In some implementations, when the method proceeds to mode A at 315, the host obtains host-side playback information at 320 (e.g., “get host audio”). The host-side playback information can include a monitored digital playback level expressed relative to full scale (dBFS) and a gain setting (e.g., a volume setting). In some implementations, the host further obtains a sensitivity calibration value associated with the remote audio device (e.g., a static value indicating a maximum SPL at 0 dBFS), which enables the host to map digital playback levels to corresponding physical SPL estimates.

In mode A, the host estimates a playback contribution to SPL using host-side playback parameters and the sensitivity calibration. In some implementations, a playback SPL estimate is determined in a logarithmic dB scale according to:

$$Playback\_SPL \_dB = Digital\_Level \_dBFS + Gain\_dB + Sensitivity\_dBSPL \_at \_ 0 dBFS$$

In parallel, the remote payload received at 305 can represent a residual ambient contribution reaching the ear, such as a residual SPL derived from an ambient SPL measurement reduced by an effective attenuation metric (e.g., total insertion loss), for example:

$$Residual\_SPL \_dB = max ( Ambient\_SPL \_dB - IL\_total \_dB , 0 )$$

Thus, in various examples, the hybrid architecture can be used with devices that lack an in-ear microphone while still accounting for environmental noise and attenuation behavior.

At 325, the host combines the playback contribution and the residual ambient contribution to determine an effective SPL at the ear for a selected measurement window. In some implementations, the combination is performed in an energy domain based on an assumption that the playback signal and the residual environmental noise are substantially uncorrelated sound sources. Because decibels are logarithmic, the host converts each contribution to a linear energy representation, sums the energies, and converts back to decibels, for example:

$$Effective\_SPL \_dB = 10 \cdot log 10 ( {10}^{Playback \_ SPL \_ dB / 10} + 1 {0}^{Residual \_ SPL \_ dB / 10} )$$

In some implementations, consistent weighting (e.g., A-weighting) is applied to the terms so that the contributions can be combined on a common basis.

In some implementations, if the remote device supports direct in-ear measurement, the method 300 proceeds from 310 along the “YES” branch to mode B 330, and the host uses the payload directly at 335. When the method 300 proceeds to mode B at 330, the remote device provides a direct measurement of in-ear SPL, and the host bypasses the hybrid fusion determinations. At 335, the host uses the payload directly as an in-ear SPL value, thereby enabling higher-fidelity exposure estimation when an in-ear microphone is available to capture the combined physical sound at or near the eardrum. The combined physical sound includes both playback audio and environmental noise that reaches the ear. In some examples, the techniques utilized in mode B at 330 can be used, for example, with higher-end devices equipped with an in-ear microphone, while a consistent host-side exposure tracking framework is provided across a heterogeneous set of remote audio devices.

At 340, the host updates the dose based on the effective SPL determined via mode A or mode B. In some implementations, the host uses its own system clock to determine the duration of the measurement window and to integrate acoustic energy over the selected duration to update a cumulative exposure metric in a policy-neutral manner. This approach allows the host to apply one or more regulatory or proprietary exposure policies, such as WHO or ETSI-based criteria, without clock synchronization or continuous high-bandwidth streaming from the remote device. In some examples, the exposure policies correspond to hearing-health guidance or regulatory limits, and the policies can be used to convert integrated exposure into user-facing outputs such as warnings, notifications, or dose progress indicators.

As reflected in FIG. 3, the method 300 enables a single host-side implementation to support multiple hardware tiers of remote audio devices, ranging from low-cost earbuds to premium headsets with in-ear microphones. By selectively applying mode A or mode B processing based on reported device capabilities, the system achieves accurate sound exposure estimation while minimizing power consumption, radio-on time, and computational complexity on the remote device.

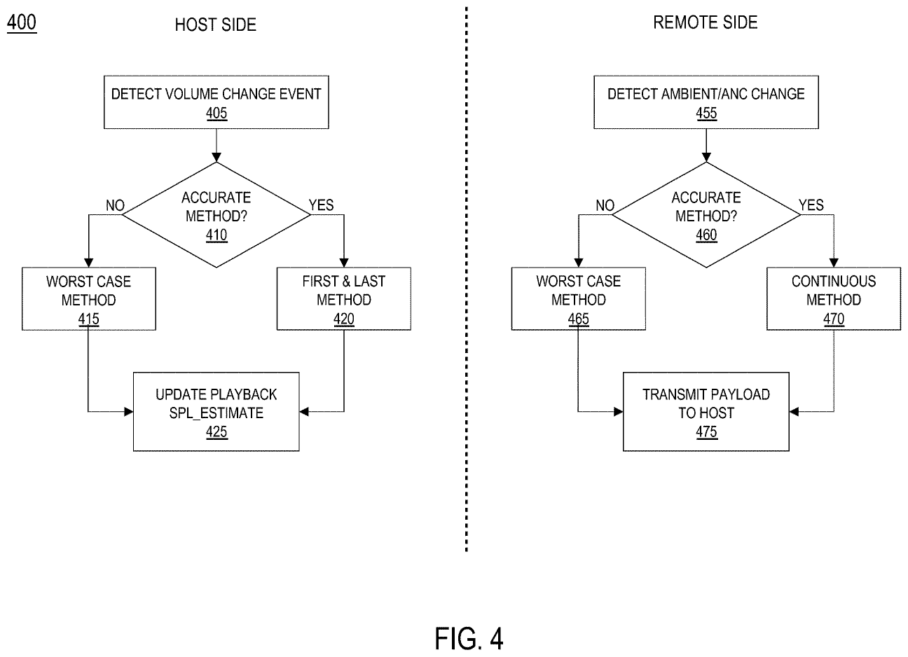

FIG. 4 illustrates an example method 400 for managing runtime changes that can affect a listener's estimated sound exposure in a distributed architecture, in accordance with various embodiments. In particular, the method 400 is performed in a system in which a host device performs dose integration while a remote audio device provides one or more measured or derived acoustic metrics. As shown in FIG. 4, the method 400 is divided between a host side and a remote side, reflecting that different portions of the overall exposure estimate are influenced by playback conditions under host control, and environmental and attenuation conditions sensed or determined at the remote audio device.

On the host side, the method 400 detects a volume change event at 405, such as a user adjustment of a playback volume setting, gain, or other host-controlled audio parameter that changes the playback contribution to in-ear sound pressure level. At 410, the host device determines which sound exposure method is currently enabled. In particular, at 410, the host device determines whether an accuracy-optimized method or an efficiency-optimized method is currently enabled. In various examples, the accuracy-optimized method includes integrating volume levels using separate, window-aligned segments, and the efficiency-optimized method includes applying the maximum volume gain that occurred during a selected segment. In some examples, the determination at 410 supports selectively trading computational and signaling overhead for improved temporal accuracy of the playback sound pressure level estimate used for dose integration.

At 410, when the accurate method is not selected, the host proceeds to a worst-case method path at 415. In the worst-case method, the host can conservatively apply a maximum volume gain observed during a measurement window to the entire duration of that window, thereby avoiding underestimation of dose while limiting additional protocol transactions. In some examples, in the worst-case method, the host can apply any other selected conservative bound on the playback level to reduce overhead. At 425, the host can update a playback SPL estimate using the selected conservative value(s), which can be combined with calibration information (e.g., sensitivity mapping digital level to physical SPL) to maintain a safe and computationally efficient estimate.

When the accurate method is selected at 410, the host proceeds to a “first & last” method path at 420. In the first & last method, the host can trigger additional boundary-aligned measurements around the time of the volume change so that dose integration more accurately reflects the stable period before the change and the stable period after the change settles, rather than applying a single conservative value across the entire window. In some examples, in the first & last method, the host triggers a snapshot immediately before (or at) a volume-change boundary and another snapshot after the volume change settles. At 425, the host can update the playback SPL estimate using the refined segmentation associated with the additional boundary measurements, enabling higher fidelity integration without continuous high-bandwidth streaming.

On the remote side, at 455, an ambient noise change and/or an acoustic noise cancellation (ANC) change is detected. The ambient noise change or the acoustic noise cancellation change may correspond to changes in environmental noise conditions and/or changes in effective attenuation (e.g., insertion loss) associated with active noise cancellation state or level adjustments. At 460, the remote device evaluates whether an accurate sound exposure measurement method is enabled, similar to the decision at 410. The remote side thereby supports a similar precision-versus-efficiency selection for the environmental and attenuation contribution that ultimately affects the estimated combined in-ear sound pressure level.

When the accurate method is not selected at 460, the method 400 proceeds to a worst-case method path at 465. In the worst-case method, the remote device can track and report conservative bounds over the window, such as a maximum ambient SPL and a minimum total insertion loss observed during the window, which yields a conservative residual contribution that avoids underestimation while simplifying on-device processing and reducing power consumption. The estimated payload can be window-aligned with host-defined boundaries. At 475, the estimated payload is transmitted to the host. In some examples, the estimated payload can be conveyed using a compact command/response interface to reduce radio on-time.

When the accurate method is selected at 460, the method 400 proceeds to a continuous method path at 470. In the continuous method, the remote device can perform ongoing energy accumulation over the selected window (in contrast to only tracking conservative extrema as in the worst-case method) to determine a payload that more closely represents the integrated environmental contribution over the measurement interval. The continuous method approach improves accuracy for dynamic environments or changing attenuation settings, while still supporting periodic reporting aligned to host-defined measurement windows and avoiding the need for explicit timestamp synchronization between devices. At 475, the determined payload is transmitted to the host. In some examples, the determined payload can be conveyed using a compact command/response interface to reduce radio on-time.

According to various implementations, FIG. 4 illustrates coordinated host-side and remote-side strategies for handling two principal runtime variables that influence dose accuracy: playback volume changes and ambient noise/attenuation changes. Additionally, the method 400 allows implementations to switch between conservative, low-overhead operation and higher-accuracy operation. Thus, the method provides a scalable solution that works across a range of remote device hardware tiers and usage patterns, with the host maintaining timing and dose integration and the remote device supplying lightweight, window-aligned metrics suitable for safe listening feedback under applicable exposure policies.

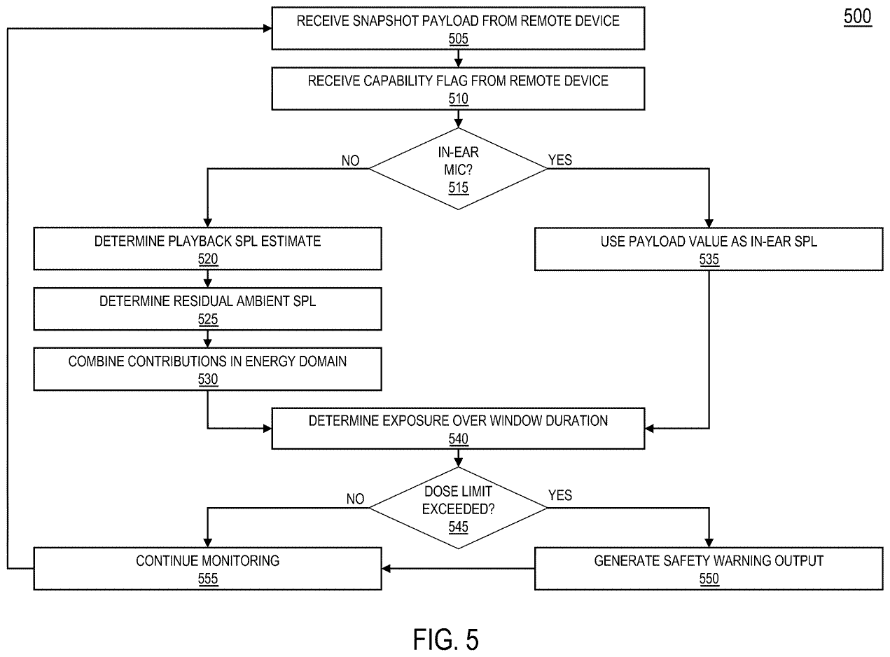

FIG. 5 illustrates an example flowchart of a method 500 in which a host device cooperates with a remote audio device to estimate a combined in-ear sound exposure level, in accordance with various embodiments. In particular, the host device estimates the combined in-ear sound exposure level over successive host-defined measurement windows. Additionally, the host device can generate user feedback when an exposure criterion is satisfied. In the method 500, the host operates as a central calculation engine and system clock, while the remote audio device functions as a lightweight sensing node that reports compact, window-aligned metrics without continuous streaming of raw microphone samples.

At 505, the host receives a snapshot payload from the remote audio device. In some implementations, the snapshot payload is returned in response to a host-initiated command that defines a measurement boundary. Thus, the payload corresponds to an interval since a previous boundary, and the remote device resets internal accumulation state after responding. In various examples, the host-framed reporting allows each received payload to be inherently aligned to a host-defined window without the remote device providing absolute timestamps or participating in clock synchronization.

At 510, the host receives a capability flag (or other capability indicator) from the remote audio device. The capability flag may indicate, for example, whether an ambient microphone measurement is valid, whether an in-ear microphone measurement is valid, and/or whether an attenuation feature such as active noise cancellation is enabled. In some implementations, the capability information is conveyed alongside a static sensitivity value that enables mapping from a digital playback level to a corresponding physical sound pressure level, thereby permitting immediate determination of playback contribution at the host.

At 515, the host determines whether an in-ear microphone capability is present and valid for the current reporting interval. If, at 515, the in-ear microphone capability is present and valid, the method 500 proceeds to 535 and the host uses the payload value as an in-ear sound pressure level. In the direct measurement mode, the in-ear microphone captures a combined physical sound field at or near the eardrum (including playback audio and environmental noise), allowing the host to bypass hybrid fusion determinations and to use the reported in-ear level directly for exposure integration over the measurement window.

At 515, if the in-ear microphone capability is not present and/or not valid, the method 500 proceeds to 520 and the host performs a hybrid estimation suitable for remote devices that do not include an in-ear microphone. In particular, at 520, the host determines a playback SPL estimate based on host-available playback information, including a digital signal level (e.g., dBFS) and gain/volume settings, together with a sensitivity calibration value associated with the remote audio device. In some implementations, the digital signal level, the gain/volume settings, and the sensitivity calibration value are combined in a logarithmic domain, and the host determines a physical playback level estimate without relying on the remote device to perform dose integration or other heavy computations.

At 525, the host device determines a residual ambient SPL representing environmental noise reaching the ear after attenuation by the remote audio device. In some implementations, the residual ambient SPL is derived from an ambient sound pressure level measurement and an effective attenuation value, such as total insertion loss. Insertion loss can represent attenuation that is subtracted from ambient level (optionally bounded to avoid negative values). In various examples, the residual term enables the host to account for real-world environmental noise and attenuation changes that would otherwise be ignored by host-only, volume-based exposure estimation.

At 530, the host device combines the playback contribution and the residual ambient contribution in the energy domain to determine a combined in-ear level estimate for the window. Because decibels are logarithmic, the host may convert each level to a linear energy representation, sum the energies, and convert the result back to decibels, thereby treating playback audio and residual environmental noise as uncorrelated sources.

At 540, the host device determines exposure over a window duration using the combined in-ear level produced via the direct-measurement path (at 535) or the hybrid-estimation path (at 520, 525, and 530). In some implementations, the host uses its system clock to determine the duration associated with each host-defined window boundary and integrates acoustic energy over the determined duration to update an accumulated exposure measure (e.g., SEL and/or dose) under a selectable exposure policy, without the remote audio device providing absolute timestamps or participating in clock alignment.

At 545, the host device determines whether a dose limit has been exceeded based on the accumulated exposure state and a configurable criterion (e.g., a criterion aligned with a safety standard or policy). If the criterion is satisfied, at 550, the host device generates a safety warning output, which may include a notification, alert, or other user-facing output indicating that exposure has reached or exceeded a limit. If the criterion is not satisfied, the method 500 proceeds to 555 to continue monitoring, after which the host receives subsequent snapshot payloads at 505 for additional windows, thereby maintaining an ongoing, window-aligned exposure estimate across changing playback and environmental conditions.

### Example Communication Packet for Distributed Sound Exposure Estimation

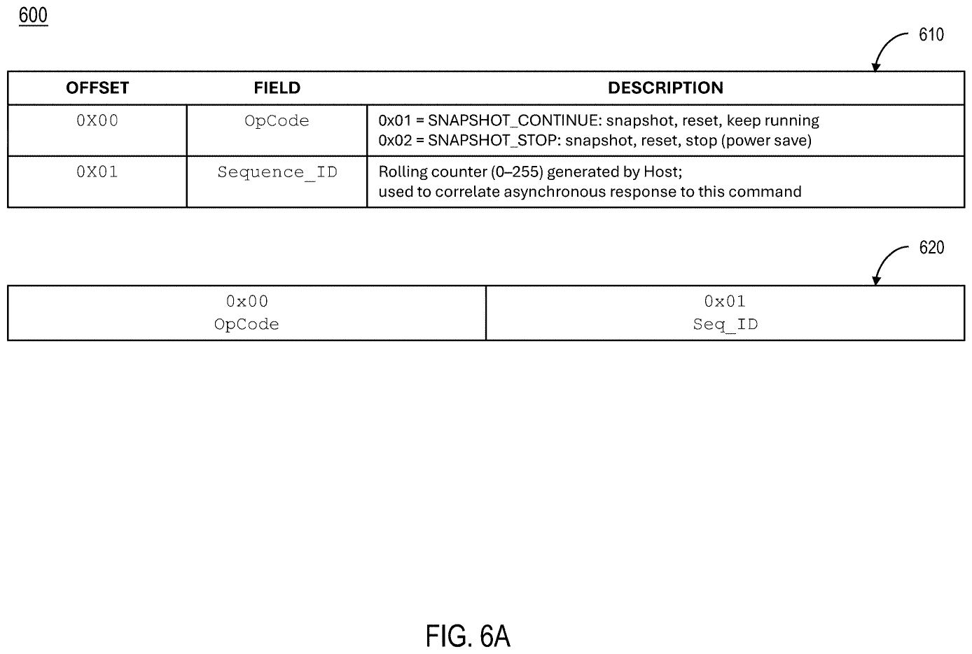

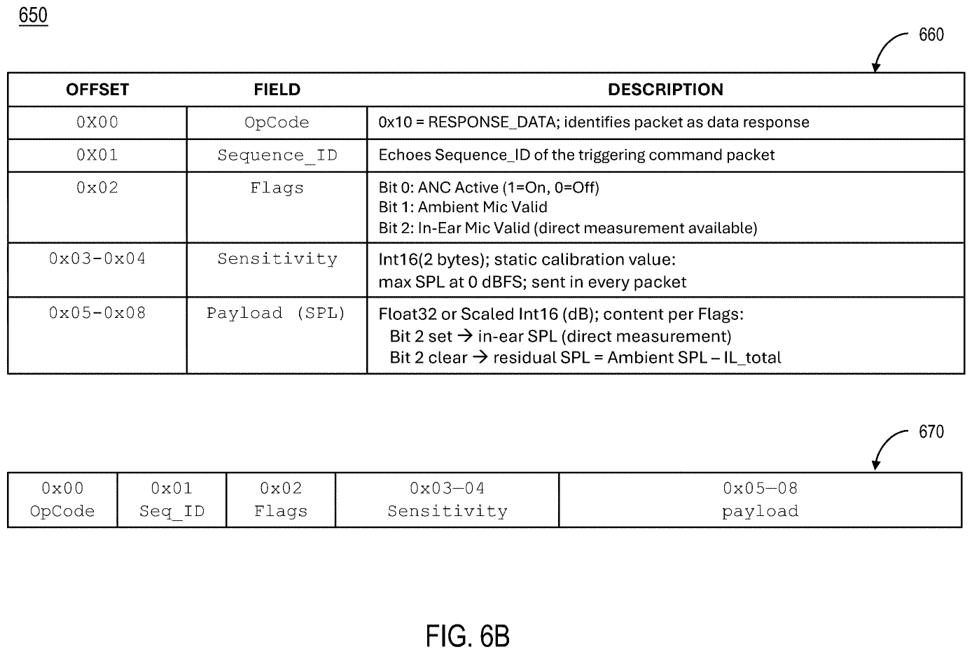

FIGS. 6A-6B illustrate example compact command/response packets 600, 650 for exchanging window-aligned sound exposure telemetry between a host device and a remote audio device, in accordance with various embodiments. In some examples, the example compact command/response packets 600, 650 can be exchanged over a wireless interface, such as Bluetooth. The example format illustrated in FIGS. 6A-6B supports a “host-framed accumulation” approach in which the host defines measurement boundaries by issuing snapshot commands and the remote audio device returns aggregate metrics for the interval since the preceding boundary. Thus, the example packets can be used in an approach that avoids continuous high-bandwidth streaming and reliance on clock synchronization between devices.

Referring to FIG. 6A, a command packet 610 (and corresponding byte layout 620) includes an OpCode field at offset 0x00 and a Sequence_ID field at offset 0x01. The OpCode may indicate, for example, a snapshot-and-continue operation that causes the remote audio device to snapshot its current aggregate measurement, reset its accumulators, and continue running, or a snapshot-and-stop operation that causes the remote audio device to snapshot, reset, and stop a measurement engine to conserve power. The Sequence_ID may be a rolling counter generated by the host and included to correlate an asynchronous response with the triggering command, thereby enabling robust association of window data with the host-defined measurement boundaries.

Referring to FIG. 6B, a response packet 660 (and corresponding byte layout 670) may be transmitted from the remote audio device to the host promptly after the remote processes the command packet. The response packet includes an OpCode at offset 0x00 that identifies the packet as a data response, and a Sequence_ID at offset 0x01 that echoes the Sequence_ID of the triggering command, enabling the host to associate the returned telemetry with the correct measurement window. A flags field at offset 0x02 provides a compact capability and state indication, such as whether active noise cancellation is active, whether an ambient microphone measurement is valid, and whether an in-ear microphone measurement is valid (i.e., direct in-ear measurement available).

The response packet 660 further includes a sensitivity field at offsets 0x03-0x04, which may be represented as an integer value and may correspond to a static calibration parameter (e.g., a maximum SPL at 0 dBFS). By including the sensitivity field in each response, the host can immediately compute a playback contribution to exposure using host-available digital playback information (e.g., dBFS level and gain) without using a separate database lookup or additional handshake, thereby improving interoperability across remote device vendors and reducing implementation complexity at the host.

The response packet 660 also includes a payload field at offsets 0x05-0x08 that represents an SPL-related measurement in a compact numerical format (e.g., floating-point or scaled integer). The content of the payload field can be interpreted based on the flags field. In one mode, when an in-ear microphone is valid, the payload conveys an in-ear SPL value that represents a direct measurement at or near the eardrum. In another mode, when an in-ear microphone is not valid but an ambient microphone is valid, the payload conveys a residual SPL value derived from environmental sound and effective attenuation, such that the residual SPL corresponds to an ambient SPL reduced by a total insertion loss value. The dual interpretation allows a single host-side driver and dose engine to scale across different hardware tiers, including cost-effective devices that provide ambient/attenuation metrics and premium devices that provide direct in-ear measurement.

According to various implementations, FIGS. 6A-6B illustrate a low-overhead telemetry interface that minimizes radio on-time and power consumption while allowing the host to perform sound exposure integration using host-side timing. In operation, the host issues snapshot commands at selected intervals to define windows; the remote returns window-aligned aggregate metrics and device calibration/capability indicators, and the host uses those values to estimate a combined in-ear SPL and update exposure state under a selected safety policy. The architecture supports accurate monitoring in real-world environments, including conditions in which environmental noise and attenuation changes would otherwise cause host-only, volume-based estimation to underestimate exposure.

### Example DNN System

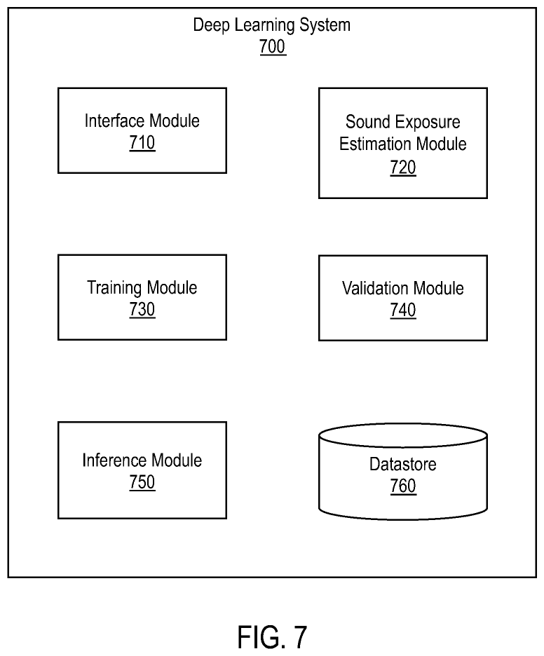

FIG. 7 is a block diagram of a deep learning system 700 that can be used for distributed sound exposure estimation, in accordance with various embodiments. In some embodiments, the deep learning system 700 is a deep neural network (DNN) system executed at a host device that serves as a central calculation engine for estimating a listener's sound exposure over time while receiving window-aligned telemetry from a remote audio device. In some embodiments, the deep learning system 700 trains and/or deploys DNNs for tasks including distributed sound exposure estimation based on host-side playback information and remote-side measurements.

In the embodiment of FIG. 7, the deep learning system 700 includes an interface module 710, a sound exposure estimation module 720, a training module 730, a validation module 740, an inference module 750, and a datastore 760. In other embodiments, alternative configurations, different or additional components may be included in the deep learning system 700. Further, functionality attributed to a component of the deep learning system 700 may be accomplished by a different component included in the deep learning system 700 or a different module or system.

The interface module 710 facilitates communication of the deep learning system 700 with other modules or systems. For example, the interface module 710 can establish communications between the host device and a remote audio device to receive snapshot payloads corresponding to host-defined measurement windows, and to receive device capability information and calibration information usable for sound exposure estimation. In some embodiments, the capability information can indicate whether an ambient microphone measurement is valid, whether an in-ear microphone measurement is valid, and/or whether an attenuation mode such as active noise cancellation is active, and the calibration information can include a sensitivity parameter usable to map host-side digital playback level to a physical sound pressure level.

The sound exposure estimation module 720 performs estimation of sound exposure using one or more estimation techniques. In some embodiments, the sound exposure estimation module 720 uses a DNN to receive input features that include (i) host-side playback information (e.g., a digital playback level and a gain/volume setting), and (ii) remote-side telemetry describing environmental noise and attenuation over a window (e.g., ambient-related and/or residual-related information), and generates an output representing an estimated combined in-ear sound pressure level and/or an exposure increment for the window. In some embodiments, the host device uses host-side timing to integrate exposure over successive windows and applies a selected policy to determine whether to generate a safety warning output.

The training module 730 trains one or more DNNs by using a training dataset. In some embodiments, the training dataset includes samples representing combinations of host-side playback parameters and remote-reported telemetry values, along with labels indicating a desired target output such as a combined in-ear sound pressure level and/or an exposure metric. The training module 730 may modify internal parameters of the DNN to reduce an error between DNN-generated outputs and the labels, and may determine one or more hyperparameters controlling the training process and/or a DNN architecture.

The validation module 740 verifies performance of trained DNNs. In some embodiments, the validation module 740 inputs samples in a validation dataset into a trained DNN and determines an accuracy or error score for one or more exposure-related outputs. In some embodiments, when the validation module 740 determines that performance does not satisfy a threshold or stopping condition, the validation module 740 instructs the training module 730 to re-train or fine-tune the DNN.

The inference module 750 applies a trained or validated DNN to perform distributed sound exposure estimation during operation. In some embodiments, the inference module 750 receives real-world input values including host-side playback parameters and remote-device telemetry for a current measurement window and outputs one or more exposure-related values usable by the host device to update an exposure state and/or determine whether to provide user feedback. In some embodiments, the host device aggregates outputs across successive windows and generates a safety warning output when an exposure limit is approached or exceeded.

The datastore 760 stores data received, generated, used, or otherwise associated with the deep learning system 700. For example, the datastore 760 may store training datasets, validation datasets, model parameters, and hyperparameters. In some embodiments, the datastore 760 further stores calibration information (e.g., sensitivity values) and exposure history values associated with monitoring exposure across multiple measurement windows.

### Example Computing Device

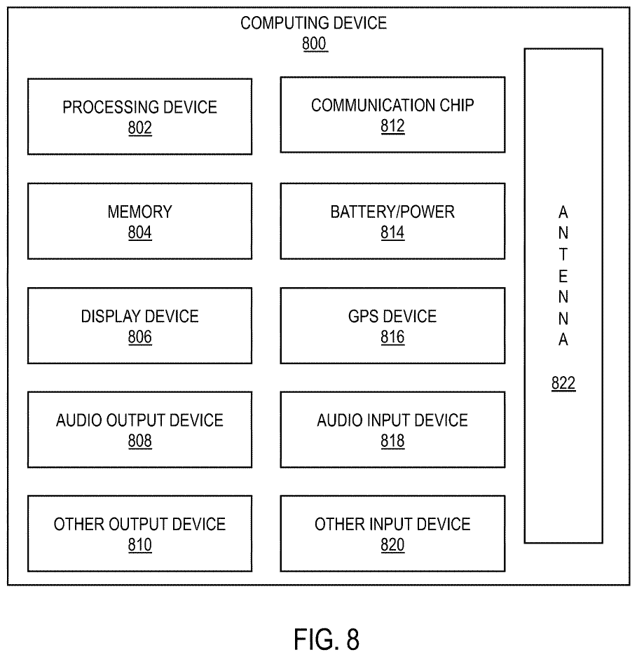

FIG. 8 is a block diagram of an example computing device 800, in accordance with various embodiments. In some embodiments, the computing device 800 may be used for at least part of the systems in FIGS. 1-6. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system-on-chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include a video input device 818 or a video output device 808, but may include video input or output device interface circuitry (e.g., connectors and supporting circuitry) to which a video input device 818 or video output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 804 may include memory that shares a die with the processing device 802. In some embodiments, the memory 804 includes one or more non-transitory computer-readable media storing instructions executable for distributed sound exposure estimation, e.g., the methods discussed herein or some operations performed by the DNN system 700 in FIG. 7. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### SELECT EXAMPLES

Example 1 provides an apparatus, including a computer processor for executing computer program instructions; and a non-transitory computer-readable memory storing computer program instructions executable by the computer processor to perform operations including transmitting, from a host device to a remote audio device, a first snapshot command and a second snapshot command, the first snapshot command and the second snapshot command defining a measurement window; receiving, at the host device, capability data and a payload from the remote audio device, the payload corresponding to the measurement window, and the capability data indicating a presence of an in-ear microphone at the remote device; determining, using a host system clock, a duration of the measurement window; generating a combined in-ear sound pressure level based, at least in part, on the payload and the capability data; and integrating the combined in-ear sound pressure level over the duration of the measurement window to generate a sound exposure dose estimate.

Example 2 provides the apparatus of example 1, the operations further including determining, based on the capability data, that the payload represents a residual ambient sound pressure level.

Example 3 provides the apparatus of example 2, the operations further including determining, for the measurement window, a playback sound pressure level based on a digital audio level and gain; and where generating the combined in-ear sound pressure level includes combining the playback sound pressure level and the residual ambient sound pressure level.

Example 4 provides the apparatus of any one of examples 1-3, the operations further including determining, based on the capability data, that the payload represents an in-ear sound pressure level measured by an in-ear microphone of the remote audio device.

Example 5 provides the apparatus of any one of examples 1-4, where generating the combined in-ear sound pressure level includes, when the capability data indicates the presence of the in-ear microphone, using the payload as an in-ear sound pressure level; and when the capability data indicates the absence of the in-ear microphone, interpreting the payload as a residual sound pressure level derived from environmental sound and effective attenuation.

Example 6 provides the apparatus of any one of examples 1-5, where determining the duration of the measurement window includes determining the duration using the host system clock without using timestamps from the remote audio device and without clock synchronization between the host device and the remote audio device.

Example 7 provides the apparatus of any one of examples 1-6, where the measurement window is a first measurement window of a plurality of measurement windows, and where the operations further include repeating the transmitting, receiving, generating, and integrating for the plurality of measurement windows; accumulating integration results across the plurality of measurement windows to generate the sound exposure dose estimate; and applying a configurable policy function to convert the sound exposure dose estimate into user-facing dose metrics.

Example 8 provides the apparatus of any one of examples 1-7, where receiving the capability data and the payload includes receiving a response packet that includes a sensitivity calibration value usable by the host device to map a digital playback level in decibels relative to full scale (dBFS) to a physical sound pressure level.

Example 9 provides the apparatus of any one of examples 1-8, where the operations further include, responsive to detecting a playback volume change during the measurement window, selecting between: triggering an additional snapshot around the playback volume change, and applying a maximum playback gain observed during the measurement window to avoid underestimating exposure.

Example 10 provides the apparatus of any one of examples 1-9, where the remote audio device includes a window accumulator configured to accumulate noise-related energy between host-issued snapshot commands, and where the remote audio device resets the window accumulator at each command boundary such that each payload is tied to a host-defined measurement window.

Example 11 provides the apparatus of any one of examples 1-10, where transmitting the first snapshot command includes transmitting a snapshot-and-continue command that causes the remote audio device to snapshot aggregated data, reset one or more accumulators, and continue accumulating for a subsequent measurement window, and where transmitting the second snapshot command includes transmitting a snapshot-and-stop command that causes the remote audio device to stop an accumulation engine.

Example 12 provides a non-transitory computer-readable medium storing instructions executable to perform operations, the operations including transmitting, from a host device to a remote audio device, a first snapshot command and a second snapshot command, the first snapshot command and the second snapshot command defining a measurement window; receiving, at the host device, capability data and a payload from the remote audio device, the payload corresponding to the measurement window, and the capability data indicating a presence of an in-ear microphone at the remote device; determining, using a host system clock, a duration of the measurement window; generating a combined in-ear sound pressure level based, at least in part, on the payload and the capability data; and integrating the combined in-ear sound pressure level over the duration of the measurement window to generate a sound exposure dose estimate.

Example 13 provides the non-transitory computer-readable medium of example 12, the operations further including determining, based on the capability data, that the payload represents a residual ambient sound pressure level.

Example 14 provides the non-transitory computer-readable medium of example 13, the operations further including determining, for the measurement window, a playback sound pressure level based on a digital audio level and gain; and where generating the combined in-ear sound pressure level includes combining the playback sound pressure level and the residual ambient sound pressure level.

Example 15 provides the non-transitory computer-readable medium of any one of examples 12-14, the operations further including determining, based on the capability data, that the payload represents an in-ear sound pressure level measured by an in-ear microphone of the remote audio device.

Example 16 provides the non-transitory computer-readable medium of any one of examples 12-15, where generating the combined in-ear sound pressure level includes when the capability data indicates the presence of the in-ear microphone, using the payload as an in-ear sound pressure level; and when the capability data indicates the absence of the in-ear microphone, interpreting the payload as a residual sound pressure level derived from environmental sound and effective attenuation.

Example 17 provides the non-transitory computer-readable medium of any one of examples 12-16, where determining the duration of the measurement window includes determining the duration using the host system clock without using timestamps from the remote audio device and without clock synchronization between the host device and the remote audio device.

Example 18 provides the non-transitory computer-readable medium of any one of examples 12-17, where the measurement window is a first measurement window of a plurality of measurement windows, and where the operations further include repeating the transmitting, receiving, generating, and integrating for the plurality of measurement windows; accumulating integration results across the plurality of measurement windows to generate the sound exposure dose estimate; and applying a configurable policy function to convert the sound exposure dose estimate into user-facing dose metrics.

Example 19 provides the non-transitory computer-readable medium of any one of examples 12-18, where receiving the capability data and the payload includes receiving a response packet that includes a sensitivity calibration value usable by the host device to map a digital playback level in decibels relative to full scale (dBFS) to a physical sound pressure level.

Example 20 provides the non-transitory computer-readable medium of any one of examples 12-19, where the operations further include, responsive to detecting a playback volume change during the measurement window, selecting between: triggering an additional snapshot around the playback volume change, and applying a maximum playback gain observed during the measurement window to avoid underestimating exposure.

Example 21 provides the non-transitory computer-readable medium of any one of examples 12-20, where receiving the payload includes receiving the payload generated by a window accumulator of the remote audio device that accumulates noise-related energy between host-issued snapshot commands, and where the window accumulator is reset at each command boundary such that each payload is tied to a host-defined measurement window.

Example 22 provides the non-transitory computer-readable medium of any one of examples 12-21, where transmitting the first snapshot command includes transmitting a snapshot-and-continue command that causes the remote audio device to snapshot aggregated data, reset one or more accumulators, and continue accumulating for a subsequent measurement window, and where transmitting the second snapshot command includes transmitting a snapshot-and-stop command that causes the remote audio device to stop an accumulation engine.

Example 23 provides a computer-implemented method, including transmitting, from a host device to a remote audio device, a first snapshot command and a second snapshot command, the first snapshot command and the second snapshot command defining a measurement window; receiving, at the host device, capability data and a payload from the remote audio device, the payload corresponding to the measurement window, and the capability data indicating a presence of an in-ear microphone at the remote device; determining, using a host system clock, a duration of the measurement window; generating a combined in-ear sound pressure level based, at least in part, on the payload and the capability data; and integrating the combined in-ear sound pressure level over the duration of the measurement window to generate a sound exposure dose estimate.

Example 24 provides the method of example 23, where generating the combined in-ear sound pressure level includes when the capability data indicates the presence of the in-ear microphone, using the payload as an in-ear sound pressure level; and when the capability data indicates the absence of the in-ear microphone, interpreting the payload as a residual sound pressure level derived from environmental sound and effective attenuation.

Example 25 provides the method of example 23 or 24, the operations further including determining, based on the capability data, that the payload represents a residual ambient sound pressure level.

Example 26 provides the method of example 25, the operations further including determining, for the measurement window, a playback sound pressure level based on a digital audio level and gain; and where generating the combined in-ear sound pressure level includes combining the playback sound pressure level and the residual ambient sound pressure level.

Example 27 provides the method of any one of examples 23-26, the operations further including determining, based on the capability data, that the payload represents an in-ear sound pressure level measured by an in-ear microphone of the remote audio device.

Example 28 provides the method of any one of examples 23-27, where determining the duration of the measurement window includes determining the duration using the host system clock without using timestamps from the remote audio device and without clock synchronization between the host device and the remote audio device.

Example 29 provides the method of any one of examples 23-28, where the measurement window is a first measurement window of a plurality of measurement windows, and where the operations further include repeating the transmitting, receiving, generating, and integrating for the plurality of measurement windows; accumulating integration results across the plurality of measurement windows to generate the sound exposure dose estimate; and applying a configurable policy function to convert the sound exposure dose estimate into user-facing dose metrics.

Example 30 provides the method of any one of examples 23-29, where receiving the capability data and the payload includes receiving a response packet that includes a sensitivity calibration value usable by the host device to map a digital playback level in decibels relative to full scale (dBFS) to a physical sound pressure level.

Example 31 provides the method of any one of examples 23-30, where the operations further include, responsive to detecting a playback volume change during the measurement window, selecting between: triggering an additional snapshot around the playback volume change, and applying a maximum playback gain observed during the measurement window to avoid underestimating exposure.

Example 32 provides the method of any one of examples 23-31, where receiving the payload includes receiving the payload generated by a window accumulator of the remote audio device that accumulates noise-related energy between host-issued snapshot commands, and where the window accumulator is reset at each command boundary such that each payload is tied to a host-defined measurement window.

Example 33 provides the method of any one of examples 23-32, where transmitting the first snapshot command includes transmitting a snapshot-and-continue command that causes the remote audio device to snapshot aggregated data, reset one or more accumulators, and continue accumulating for a subsequent measurement window, and where transmitting the second snapshot command includes transmitting a snapshot-and-stop command that causes the remote audio device to stop an accumulation engine.

Example 34 provides a system for distributed sound exposure estimation, comprising: a host device configured to transmit snapshot commands defining measurement window boundaries and to receive, in response, window-aligned aggregate payloads from a remote audio device; and a dose engine executing on the host device and configured to determine a window duration using a host system clock, fuse a playback sound pressure level derived from a digital audio level and gain with a residual ambient sound pressure level derived from the received payload, and integrate a combined in-ear sound pressure level across consecutive measurement windows to generate a sound exposure dose estimate.

Example 35 provides a computer-implemented method, comprising: receiving, at a host device, from a remote audio device via a wireless link, window-aligned data including a payload representative of sound pressure level (SPL) at or near a user's ear; determining, based on capability information from the remote audio device, whether an in-ear microphone measurement is valid; responsive to the in-ear microphone measurement being valid, using the payload as an in-ear SPL; responsive to the in-ear microphone measurement being invalid, obtaining host audio information including a digital playback level in dBFS and a gain setting, and combining a playback SPL estimate with the payload in an energy domain to determine an effective SPL; and updating a dose based on the effective SPL.

Example 36 provides a computer-implemented method for estimating sound exposure, comprising: receiving, at a host device from a remote audio device, a measurement payload and a capability flag indicating whether the remote audio device includes an in-ear microphone; determining that the capability flag indicates no in-ear microphone; determining a combined in-ear sound pressure level by combining, in an energy domain, a playback sound pressure level estimated from digital audio level and gain with a residual ambient sound pressure level derived from reported ambient sound pressure level and total insertion loss; and integrating the combined in-ear sound pressure level over time using a host system clock to produce a sound exposure dose estimate.

Example 37 provides a remote audio device for distributed sound exposure estimation, comprising: an ambient microphone and active noise cancellation digital signal processor configured to measure ambient sound pressure level; a window accumulator configured to accumulate aggregate environmental metrics between snapshot commands received from a host device; and a wireless transceiver configured to transmit, in response to each snapshot command, a measurement payload comprising the accumulated aggregate metrics and a static sensitivity calibration value, and to reset the window accumulator upon transmission to begin accumulation for a subsequent measurement window.

Example 38 provides the apparatus, computer-readable medium, and/or method of any of the above examples, wherein interpreting the payload as the residual sound pressure level comprises: obtaining, from the remote audio device, an ambient sound pressure level measured by an ambient microphone and a total insertion loss value; and subtracting the total insertion loss value from the ambient sound pressure level to determine the residual sound pressure level.

Example 39 provides the apparatus, computer-readable medium, and/or method of example 38, further comprising determining ambient sound pressure level based, in part, on passive isolation and active noise cancellation attenuation.

Example 40 provides the apparatus, computer-readable medium, and/or method of any of the above examples, wherein the operations further comprise receiving, from the remote audio device, a worst-case ambient payload comprising a maximum ambient sound pressure level observed during the measurement window, and wherein generating the combined in-ear sound pressure level uses the maximum ambient sound pressure level and a minimum total insertion loss to avoid underestimating exposure.

Example 41 provides the apparatus, computer-readable medium, and/or method of any of the above examples, wherein transmitting the first snapshot command comprises including a sequence identifier generated by the host device in the first snapshot command, and wherein receiving the capability data and the payload comprises receiving a response packet that echoes the sequence identifier, and wherein the host device correlates the response packet to the first snapshot command using the echoed sequence identifier without maintaining persistent session state.

Example 42 provides a computer-implemented method comprising: transmitting, from a host device to a remote audio device, snapshot commands defining measurement window boundaries; receiving, at the host device, a payload from the remote audio device representing a sound pressure level at or near a user's ear, the payload corresponding to a measurement window defined by the snapshot commands; determining, using a host system clock, a duration of the measurement window; and integrating a sound pressure level derived from the payload over the duration of the measurement window to generate a sound exposure dose estimate.

Example 43 provides the apparatus, computer-readable medium, and/or method of any of the above examples, wherein the first snapshot command includes a snapshot-and-continue instruction and the second snapshot command includes a snapshot-and-stop instruction, the first snapshot command and the second snapshot command defining a measurement window.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
transmitting, from a host device to a remote audio device, a first snapshot command and a second snapshot command, the first snapshot command and the second snapshot command defining a measurement window;
receiving, at the host device, capability data and a payload from the remote audio device, the payload corresponding to the measurement window, and the capability data indicating a presence of an in-ear microphone at the remote audio device;
determining, using a host system clock, a duration of the measurement window;
generating a combined in-ear sound pressure level based, at least in part, on the payload and the capability data; and
integrating the combined in-ear sound pressure level over the duration of the measurement window to generate a sound exposure dose estimate.

2. The apparatus of claim 1, the operations further comprising determining, based on the capability data, that the payload represents a residual ambient sound pressure level.

3. The apparatus of claim 2, the operations further comprising: determining, for the measurement window, a playback sound pressure level based on a digital audio level and gain; and wherein generating the combined in-ear sound pressure level includes combining the playback sound pressure level and the residual ambient sound pressure level.

4. The apparatus of claim 1, the operations further comprising determining, based on the capability data, that the payload represents an in-ear sound pressure level measured by an in-ear microphone of the remote audio device.

5. The apparatus of claim 1, wherein generating the combined in-ear sound pressure level comprises:
when the capability data indicates the presence of the in-ear microphone, using the payload as an in-ear sound pressure level; and
when the capability data indicates absence of the in-ear microphone, interpreting the payload as a residual sound pressure level derived from environmental sound and effective attenuation.

6. The apparatus of claim 1, wherein determining the duration of the measurement window comprises determining the duration using the host system clock without using timestamps from the remote audio device and without clock synchronization between the host device and the remote audio device.

7. The apparatus of claim 1, wherein the measurement window is a first measurement window of a plurality of measurement windows, and wherein the operations further comprise:
repeating the transmitting, receiving, generating, and integrating for the plurality of measurement windows;
accumulating integration results across the plurality of measurement windows to generate the sound exposure dose estimate; and
applying a configurable policy function to convert the sound exposure dose estimate into user-facing dose metrics.

8. The apparatus of claim 1, wherein receiving the capability data and the payload comprises receiving a response packet that includes a sensitivity calibration value usable by the host device to map a digital playback level in decibels relative to full scale (dBFS) to a physical sound pressure level.

9. The apparatus of claim 1, wherein the operations further comprise, responsive to detecting a playback volume change during the measurement window, selecting between:
triggering an additional snapshot around the playback volume change, and
applying a maximum playback gain observed during the measurement window to avoid underestimating exposure.

10. A non-transitory computer-readable medium storing instructions executable to perform operations, the operations comprising:
transmitting, from a host device to a remote audio device, a first snapshot command and a second snapshot command, the first snapshot command and the second snapshot command defining a measurement window;
receiving, at the host device, capability data and a payload from the remote audio device, the payload corresponding to the measurement window, and the capability data indicating a presence of an in-ear microphone at the remote audio device;
determining, using a host system clock, a duration of the measurement window;
generating a combined in-ear sound pressure level based, at least in part, on the payload and the capability data; and
integrating the combined in-ear sound pressure level over the duration of the measurement window to generate a sound exposure dose estimate.

11. The non-transitory computer-readable medium of claim 10, the operations further comprising determining, based on the capability data, that the payload represents a residual ambient sound pressure level.

12. The non-transitory computer-readable medium of claim 11, the operations further comprising: determining, for the measurement window, a playback sound pressure level based on a digital audio level and gain; and wherein generating the combined in-ear sound pressure level includes combining the playback sound pressure level and the residual ambient sound pressure level.

13. The non-transitory computer-readable medium of claim 10, the operations further comprising determining, based on the capability data, that the payload represents an in-ear sound pressure level measured by an in-ear microphone of the remote audio device.

14. The non-transitory computer-readable medium of claim 10, wherein generating the combined in-ear sound pressure level comprises:
when the capability data indicates the presence of the in-ear microphone, using the payload as an in-ear sound pressure level; and
when the capability data indicates absence of the in-ear microphone, interpreting the payload as a residual sound pressure level derived from environmental sound and effective attenuation.

15. The non-transitory computer-readable medium of claim 10, wherein determining the duration of the measurement window comprises determining the duration using the host system clock without using timestamps from the remote audio device and without clock synchronization between the host device and the remote audio device.

16. The non-transitory computer-readable medium of claim 10, wherein the measurement window is a first measurement window of a plurality of measurement windows, and wherein the operations further comprise:
repeating the transmitting, receiving, generating, and integrating for the plurality of measurement windows;
accumulating integration results across the plurality of measurement windows to generate the sound exposure dose estimate; and
applying a configurable policy function to convert the sound exposure dose estimate into user-facing dose metrics.

17. The non-transitory computer-readable medium of claim 10, wherein receiving the capability data and the payload comprises receiving a response packet that includes a sensitivity calibration value usable by the host device to map a digital playback level in decibels relative to full scale (dBFS) to a physical sound pressure level.

18. The non-transitory computer-readable medium of claim 10, wherein the operations further comprise, responsive to detecting a playback volume change during the measurement window, selecting between:
triggering an additional snapshot around the playback volume change, and
applying a maximum playback gain observed during the measurement window to avoid underestimating exposure.

19. A computer-implemented method, comprising:
transmitting, from a host device to a remote audio device, a first snapshot command and a second snapshot command, the first snapshot command and the second snapshot command defining a measurement window;
receiving, at the host device, capability data and a payload from the remote audio device, the payload corresponding to the measurement window, and the capability data indicating a presence of an in-ear microphone at the remote audio device;
determining, using a host system clock, a duration of the measurement window;
generating a combined in-ear sound pressure level based, at least in part, on the payload and the capability data; and
integrating the combined in-ear sound pressure level over the duration of the measurement window to generate a sound exposure dose estimate.

20. The method of claim 19, wherein generating the combined in-ear sound pressure level comprises:
when the capability data indicates the presence of the in-ear microphone, using the payload as an in-ear sound pressure level; and
when the capability data indicates absence of the in-ear microphone, interpreting the payload as a residual sound pressure level derived from environmental sound and combined attenuation.
